(19) United States
(12) Patent Application Publication
(10) Pub. No.: US 2016/0081136 A1
(43) Pub. Date: Mar. 17, 2016

(54) DISCONTINUOUS RECEPTION (DRX) USING LONGER DRX INTERVALS

(71) Applicant: InterDigital Patent Holdings, Inc., Wilmington, DE (US)

(72) Inventors: Dimitrios Karampatsis, Ruislip (GB); Behrouz Aghili, Commack, NY (US); Ana Lucia Pinheiro, Portland, OR (US)

(73) Assignee: InterDigital Patent Holdings, Inc., Wilmington, DE (US)

(21) Appl. No.: 14/951,859

(22) Filed: Nov. 25, 2015

Related U.S. Application Data
(63) Continuation of application No. 13/338,625, filed on Dec. 28, 2011, now abandoned.
(60) Provisional application No. 61/427,703, filed on Dec. 28, 2010.

(51) Int. Cl. H04W 76/04; H04W 4/00; H04W 8/02

(52) U.S. Cl. CPC H04W 76/048; H04W 8/02; H04W 4/005

(57) ABSTRACT

Wireless transmit receive units (WTRUs) and methods implemented in WTRUs are described. A method includes transmitting idle mode discontinuous reception (DRX) parameters to a serving general packet radio service (GPRS) support node (SGSN)/mobile management entity (MME) during one of a tracking area update (TAU) and a routing area update (RAU) procedure and implementing the DRX mode of operation using the transmitted DRX parameters. The DRX parameters are for a DRX mode of operation that has longer DRX intervals than a regular DRX mode of operation.

### CROSS REFERENCE TO RELATED APPLICATIONS

This application is a continuation of U.S. patent application Ser. No. 13/338,625 filed Dec. 28, 2011, which claims the benefit of U.S. provisional application No. 61/427,703, filed on Dec. 28, 2010, the contents of which are hereby incorporated by reference herein.

### BACKGROUND

Wireless transmit/receive units (WTRUs), such as machine-to-machine (M2M) type devices, may be operable in a detached state. A WTRU in the detached state may not be attached to a wireless network. By way of example, the Third Generation Partnership Project (3GPP) TS 23.060 standard provides characteristics that different types of WTRUs may have in the detached state.

For Global System for Mobile Communication (GSM) type WTRUs operating in an A/Gb mode (i.e., with a functional division that is in accordance with the use of an A or Gb interface between the radio access network (RAN) and the core network), the WTRU in an IDLE state is not attached to mobility management, the WTRU and the serving general packet radio service (GPRS) support node (SGSN) of the core network holds no valid location or routing information for the WTRU, and WTRU-related mobility management procedures are not performed. The WTRU may perform public land mobile network (PLMN) selection as well as cell selection and re-selection but may not transmit or receive data and may not be paged by the wireless network. In other words, the WTRU is not seen as being reachable in the detached state.

For Universal Mobile Telecommunication Service (UMTS) type WTRUs operating in an Iu mode (i.e., with a functional division that is in accordance with the use of an Iu-Circuit Switched (Iu-CS) or Iu-Packet Switched (Iu-PS) interface between the RAN and the core network), the WTRU may not communicate with the SGSN or Third Generation (3G)-SGSN. Neither the WTRU nor the SGSN contexts hold valid location or routing information for the WTRU. The device mobility management state machine may not react on system information related to the 3G-SGSN. In other words, the WTRU is not reachable by a 3G-SGSN because the device location is not known.

### SUMMARY

Wireless transmit receive units (WTRUs) and methods implemented in WTRUs are described. A method includes transmitting idle mode discontinuous reception (DRX) parameters to a serving general packet radio service (GPRS) support node (SGSN)/mobile management entity (MME) during one of a tracking area update (TAU) and a routing area update (RAU) procedure and implementing the DRX mode of operation using the transmitted DRX parameters. The DRX parameters are for a DRX mode of operation that has longer DRX intervals than a regular DRX mode of operation.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a block diagram illustrating an example of triggering a WTRU to attach to a cell of a wireless network via a broadcast channel;

FIG. 3 is a flow diagram illustrating a method that may be implemented in a WTRU;

FIG. 4 is a signal diagram illustrating a method of an M2M server triggering one or more WTRUs via a Gi interface;

FIG. 5 is a signal diagram illustrating a method of an M2M server triggering one or more WTRUs via a policy and charging control (PCC) infrastructure;

FIG. 6 is a signal diagram illustrating a method of an M2M server triggering one or more WTRUs via an Internet Protocol Multimedia Subsystem (IMS) network; and

FIG. 7 is a flow diagram illustrating an example of triggering a WTRU to attach to a cell of a wireless network via a paging channel.

### DETAILED DESCRIPTION

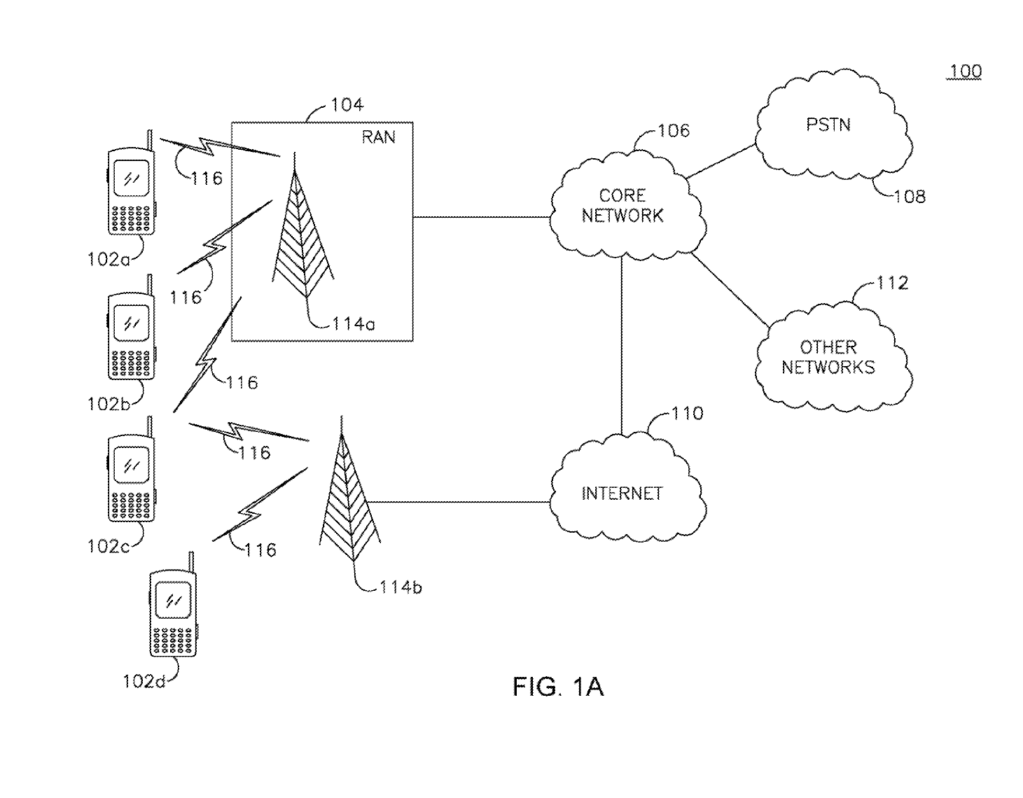

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The other networks 112 may include wired or wireless communications networks owned and/or operated by other service providers. For example, the other networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the other peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the other networks 112, which may include other wired or wireless networks that are owned and/or operated by other service providers.

A WTRU, such as the WTRU 102 shown in FIG. 1B, may be configured to perform Machine-to-Machine (M2M) communication via a wireless network, such as the wireless network illustrated in FIG. 1C. For simplicity, a WTRU configured to perform M2M communication may be referred to herein as an M2M device.

It may be desirable for a wireless network to trigger a detached WTRU to attach to the wireless network. For example, an M2M server may require information from the WTRU or have information that it needs to transmit to the WTRU. Embodiments described herein may provide methods for triggering a WTRU that is not attached to a wireless network. A WTRU that has been triggered may initiate attachment to a wireless network in order to, for example, transmit and/or receive the required information. In embodiments described herein, a WTRU may be triggered using a broadcast channel (BCCH) and/or a paging channel. In other embodiments, a low power NAS state is described in which a WTRU that is not attached to a wireless network may listen to the broadcast channel and/or the paging channel.

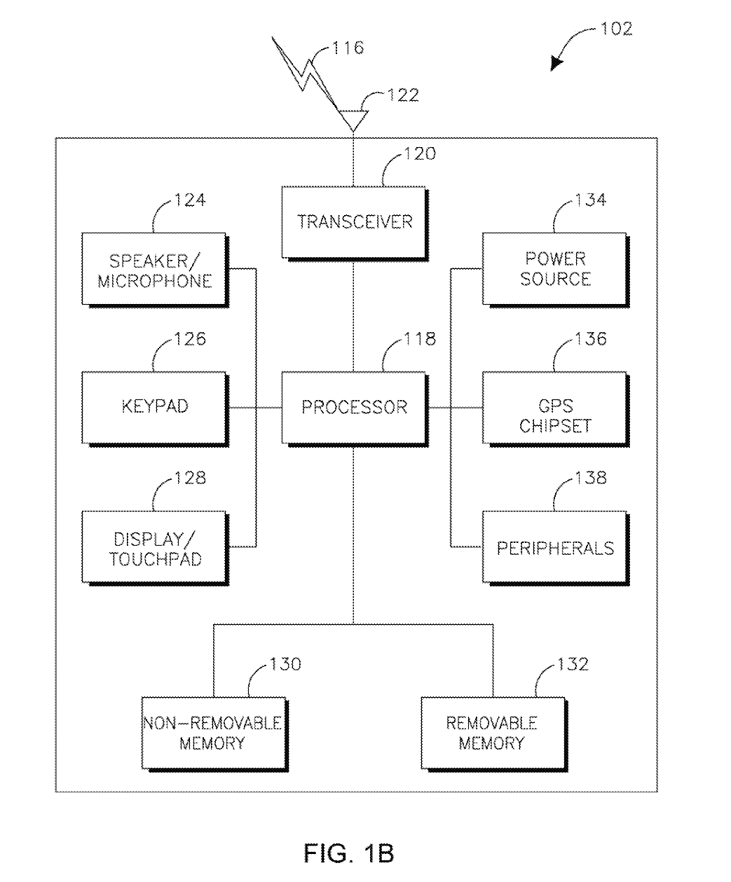

FIG. 2 is a block diagram 200 illustrating an example of triggering a WTRU to attach to a cell of a wireless network via a broadcast channel (BCCH). The illustrated embodiment may make use of a characteristic of WTRUs in a detached state wherein these WTRUs may be on a constant search to find an available network and, therefore, may be, at any given time, camped on a cell of a network and listening for cell and/or network information on the BCCH of the cell. Accordingly, an M2M server may trigger a WTRU that is not attached to a wireless network to initiate attachment to a wireless network via the BCCH of the cell that the WTRU is currently camped on.

Further, for the embodiment illustrated in FIG. 2, it may be assumed that WTRUs to be triggered either have fixed and known locations (e.g., M2M devices such as water meters, weather stations, etc.) or have a set of possible locations that the WTRU may move between. Accordingly, an M2M server that needs to trigger a WTRU to attach to a wireless network may have access to the location information for one or a select few cells through which the WTRU may be triggered and, therefore, may have the WTRU triggered at the correct location with relative ease.

The example of FIG. 2 illustrates an M2M server 202 that triggers at least one WTRU 214/216 to register with a cell 208 of a 3GPP core network 204 via a base station or radio network controller (RNC) 206. In the illustrated embodiment, the M2M server 202 sends a trigger message 203 to the 3GPP core network 204, which sends a message 205 to the base station or RNC 206 instructing the base station or RNC 206 to update BCCH information for a specified cell 208. In response to receiving the message from the 3GGP core network 204, the base station or RNC 206 may update the broadcast channel information (218) for the cell 208. The WTRUs 214 and 216 that are camped on the BCCH of the cell 208 may receive the updated BCCH information and initiate attachment to the 3GPP core network 204. Other cells 210 and 212 are illustrated in FIG. 2. Although not shown in FIG. 2, the other cells 210 and 212 may also be used to trigger wireless devices that may be listening to a BCCH of the respective cell.

The base station or RNC 206 may also provide information on the BCCH indicating whether the cell 208 supports the functionality of triggering while a WTRU is not attached to the wireless network. The WTRUs 214 and 216 may monitor the BCCH for information regarding whether a new cell supports triggering while a WTRU is not attached to the wireless network and determine whether to continue monitoring the BCCH of that cell based on this information. A WTRU 214/216 may decide to camp on a different cell (e.g., cell 210 or 212) on a condition that the cell 208 does not support triggering while a WTRU is not attached to the network 204 and to continue to monitor the BCCH of the cell 208 on a condition that the cell 208 supports triggering while a WTRU is not attached to the network 208.

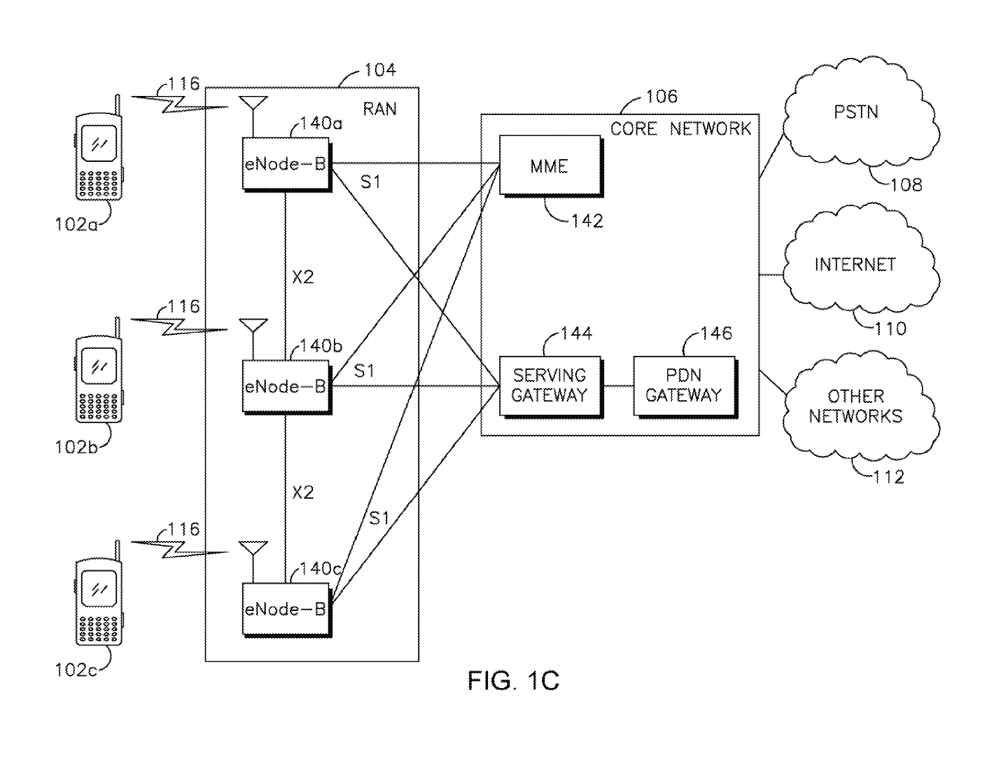

FIG. 3 is a flow diagram 300 illustrating a method that may be implemented in a WTRU (e.g., one or more of WTRUs 214 or 216 illustrated in FIG. 2). In the illustrated flow diagram 300, a WTRU monitors a broadcast channel of a cell of a wireless network for a trigger event while the WTRU is not attached to the wireless network (310). The WTRU may initiate attachment of the WTRU to the wireless network on a condition that the trigger event is detected while the broadcast channel is being monitored (320).

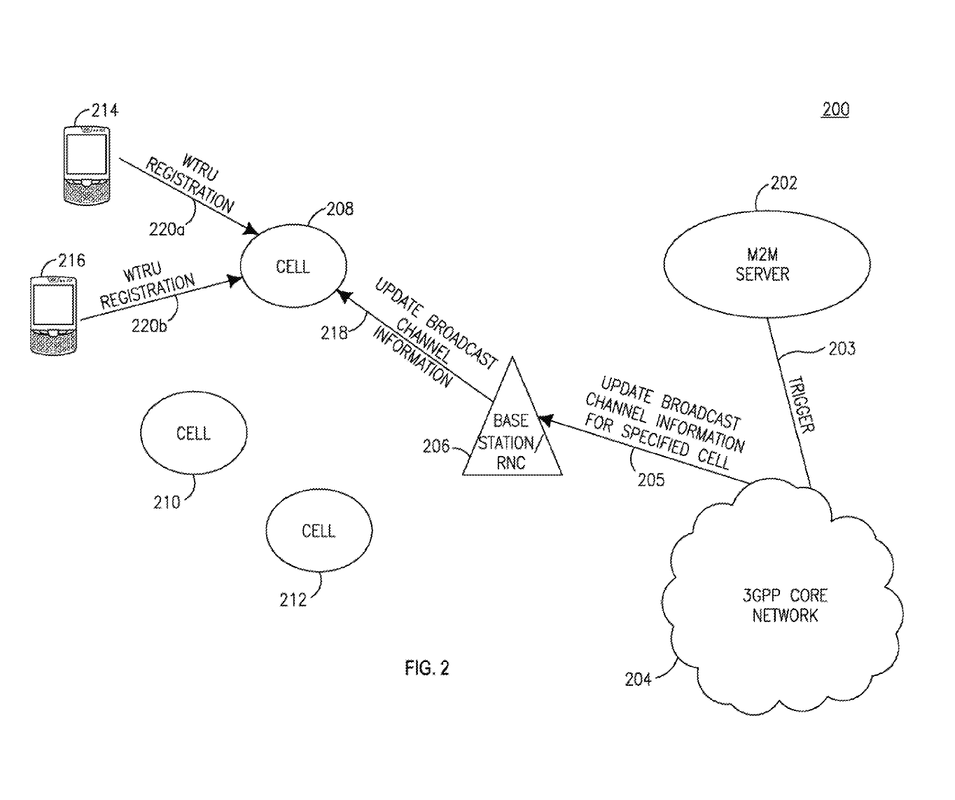

The M2M server 202 may trigger a WTRU (e.g., 214 and/or 216) to attach to a 3GPP core network 204 in a number of different ways. FIGS. 4, 5 and 6 are signal diagrams 400, 500 and 600 illustrating three example methods by which the M2M server may trigger a mobile station (MS) or WTRU.

FIG. 4 is a signal diagram 400 illustrating a method of an M2M server triggering one or more WTRUs via a Gi interface. In the example illustrated in FIG. 4, the M2M server 401 sends a trigger indication 412 to trigger a specific WTRU or group of WTRUs to attach to a mobile network. The trigger indication 412 may include a device or group identification that may allow the home location register (HLR)/home subscriber server (HSS) 404 or the SGSN/MME 406 to locate the RAN node or nodes where the one or more WTRUs 410 are located. Location information linking the device or group identification to the proper RAN node or nodes may be pre-configured in the HLR/HSS 404 or the SGSN/MME 406 and may be part of the WTRU subscription.

The trigger indication 412 may be received by the GPRS support node (GGSN)/packet data network (PDN)-gateway (P-GW) 402. Depending, for example, on where the location information is stored, the GGSN/P-GW 402 may forward the trigger indication 412 to one of the HLR/HSS 404 or the SGSN/MME 406 using one of queries 414a or 414b, respectively. If the GGSN/P-GW 402 forwards the trigger indication 412 to the HLR/HSS 404, the HLR/HSS 404 may forward the trigger indication 412 to the SGSN/MME 406 (416).

The SGSN/MME 406 may determine the location information corresponding to the WTRU identity or identities indicated in the query 414b or trigger indication 416 and send a trigger request 418 (e.g., mobility management (MM) signaling) to one or more specific basic service set (BSS)/radio network subsystem (RNS) 408 based, for example, on the location information. The one or more specific BSS/RNS 408 may broadcast an updated broadcast trigger 420 (e.g., included in a system information block (SIB) message) including a request for the one or more WTRUs 410 to attach to the wireless network (e.g., to transmit data to the M2M server 401). The one or more WTRUs 410 may detect the updated broadcast trigger 420 and initiate attachment to the wireless network using an attach procedure 422.

The GGSN/P-GW402 may run a timer to verify whether the one or more triggered MSs/WTRUs 410 attach to the wireless network. On a condition that the one or more triggered WTRUs 410 do not attach (e.g., a WTRU is not in the selected cell(s) or is not listening to the broadcast channel), the GGSN/P-GW 402 may send an error message to the M2M server 401.

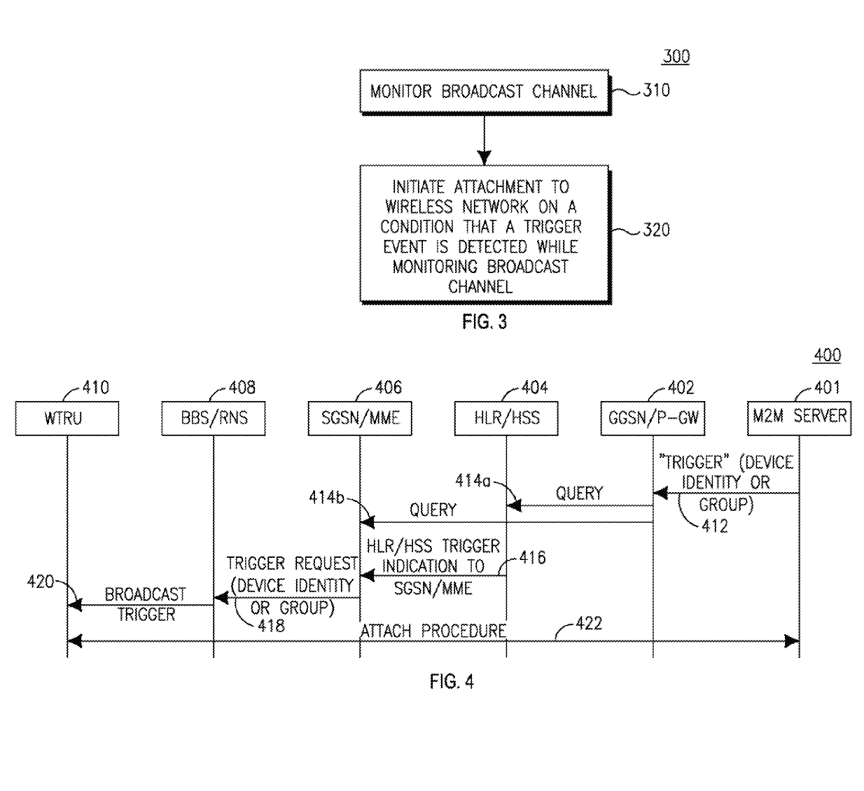

FIG. 5 is a signal diagram 500 illustrating a method of an M2M server triggering one or more WTRUs via a policy and charging control (PCC) infrastructure (e.g., for 3GPP networks implementing a user data convergence (UDC) architecture (using an SIP protocol). In the example illustrated in FIG. 5, an M2M server 501 acting as an application function (AF) sends a trigger indication 512 to trigger a specific WTRU or group of WTRUs (510) to attach to a mobile network. As for the method illustrated in FIG. 4, the trigger indication 512 may include a device or group identification that may allow the HLR/HSS 504 or the SGSN/MME 506 to locate the RAN node or nodes where the one or more WTRUs 510 are located. Location information linking the device or group identification to the proper RAN node or nodes may be pre-configured in the HLR/HSS 504 or the SGSN/MME 506 and may be part of the WTRU subscription.

The Policy and Charging Rule Function (PCRF) 502 may receive the trigger indication 512 (e.g., via an Rx interface) and forward the trigger indication 512 to the HLR/HSS 504 (514) (e.g., via a Ud interface). The HLR/HSS 504 may forward (516) the trigger indication to the SGSN/MME 506 via an S6a interface of the Ud interface.

The SGSN/MME 506 may determine the location information corresponding to the WTRU identity or identities indicated in the trigger indication 512 and send a trigger request 518 (e.g., using mobility management (MM) signaling) to one or more specific basic service set (BSS)/radio network subsystem (RNS) 508 based, for example, on the location information. The one or more specific BSS/RNS 508 may broadcast an updated broadcast trigger 520 (e.g., included in a system information block (SIB) message) including a request for the one or more WTRUs 510 to attach to the wireless network (e.g., to transmit data to the M2M server 501). The one or more WTRUs 510 may detect the updated broadcast trigger 520 and initiate attachment to the wireless network using an attach procedure 522.

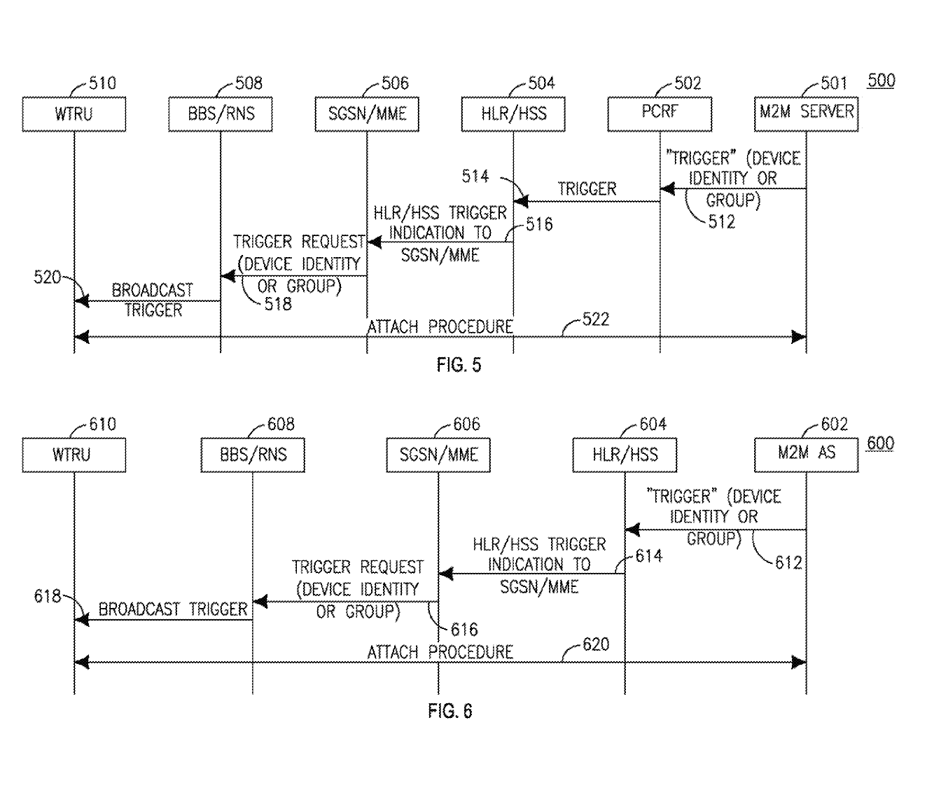

FIG. 6 is a signal diagram 600 illustrating a method of an M2M server (here an IMS application server (M2M AS)) triggering one or more WTRUs via an Internet Protocol Multimedia Subsystem (IMS) network. In the example illustrated in FIG. 6, the M2M AS 602 sends a trigger indication 612 via an Sh interface to trigger a specific WTRU or group of WTRUs (610) to attach to a wireless network. As with the method illustrated in FIGS. 4 and 5, the trigger indication 612 may include a device or group identification that may allow the HLR/HSS 604 or the SGSN/MME 606 to locate the RAN node or nodes where the one or more WTRUs 610 are located. Location information linking the device or group identification to the proper RAN node or nodes may be pre-configured in the HLR/HSS 604 or the SGSN/MME 606 and may be part of the WTRU subscription.

The HLR/HSS 604 may receive the trigger indication 612 and forward the trigger indication 612 to the SGSN/MME 606 (614) via an S6a or Ud interface. The SGSN/MME 606 may determine the location information corresponding to the WTRU identity or identities indicated in the trigger indication 612 and send a trigger request 616 (e.g., using mobility management (MM) signaling) to one or more specific BSS/RNS 608 based, for example, on the location information. The one or more specific BSS/RNS 608 may broadcast an updated broadcast trigger 618 (e.g., included in a system information block (SIB) message) including a request for the one or more specific WTRUs 610 to attach to the wireless network (e.g., to transmit data to the M2M AS 602). The one or more WTRUs 610 may detect the updated broadcast trigger 618 and initiate attachment to the wireless network using an attach procedure 620. If the Ud interface is used to forward the trigger indication 612 to the HLR/HSS 604 via the Ud interface, the GPPP wireless network may be implementing the UDS architecture.

In an embodiment, a WTRU that is not attached to a wireless network may be triggered using the paging channel. For example, some WTRUs may use a discontinuous reception (DRX) mode of operation. In the DRX mode, the WTRU may enter a sleep mode at periodic intervals of a DRX cycle. For WTRUs that are not attached to a wireless network, a WTRU may apply a specific DRX cycle including intervals having a length that is provided to the wireless network (e.g., when detaching from the wireless network). In an embodiment, the DRX intervals may have a length that is longer than the DRX intervals used by WTRUs that are attached to the wireless network.

DRX information, including information about the specific DRX cycle that may be used by a WTRU that is not attached to the wireless network and any associated DRX parameters, may be communicated to the wireless network in a number of different ways. For example, the WTRU may include the DRX information in a detach request message when in a packet system (PS)/evolved packet system (EPS). By way of another example, if the WTRU has only circuit switched (CS) access, the WTRU may include the DRX information in an international mobile subscriber identity (IMSI) detach indication message. By way of another example, the WTRU may signal the DRX information during tracking/routing/location area update procedures as new DRX information to be applied when the WTRU detaches from the wireless network.

The wireless network may use the DRX information to signal triggering information using the paging channel. By way of example, classic GSM paging messages, as well as radio resource control (RRC) paging messages (e.g., if the wireless network is a UMTS Terrestrial Radio Access Network (UTRAN) or an Enhanced UTRAN (EUTRAN)) may be used to signal the triggering information using the paging channel. For GSM paging, rest octets may also be used to convey the triggering information.

Network operators may implement the functionality of triggering via the paging channel as an option for the wireless network. In this embodiment, the wireless network may broadcast the support/availability of this functionality in system information messages or communicate it to the WTRU when it first registers with the wireless network (e.g., during an attach or tracking/routing/location update procedure). On a condition that the wireless network broadcasts the support/availability of the triggering via the paging channel functionality when the WTRU first registers with the wireless network, the information may be sent to the WTRU in one or more network access server (NAS) accept messages.

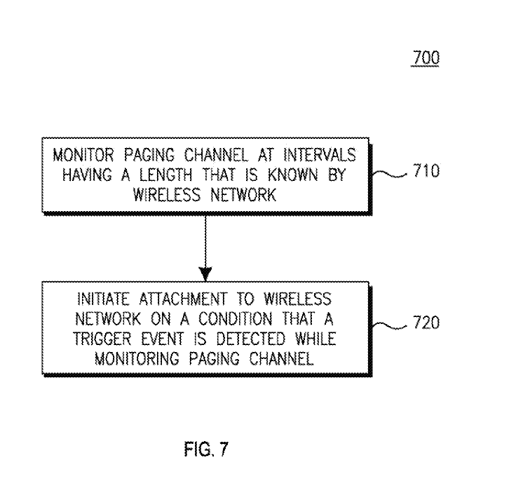

FIG. 7 is a flow diagram 700 illustrating an example of triggering a WTRU to attach to a cell of a wireless network via a paging channel. In the illustrated embodiment, a WTRU may monitor a paging channel of a cell of a wireless network for a trigger event at intervals having a length that is provided to the wireless network while the WTRU is not attached to the wireless network (710). On a condition that the trigger event is detected while the WTRU is monitoring the paging channel, the WTRU may initiate attachment of the WTRU to the wireless network (720).

In an embodiment, a WTRU that is not attached to a wireless network may be in a low power NAS state during which the WTRU listens to at least one of broadcast and paging channels. To establish communication with the network, a device in the low power state may be required to initiate an attach procedure. The WTRU may also be attached to GPRS mobility management when in the low power state, and the MS and SGSN contexts hold valid location and/or routing information for the WTRU so that the WTRU may be triggered via at least one of the broadcast channel or the paging channel. Devices in the same set may be assumed to belong to the same routing area so that the routing information does not change from WTRU to WTRU and may be used to page the WTRUs.

In an embodiment, WTRU-related mobility management procedures may not be performed in the low power state. It may be assumed that the WTRUs stay in the same routing area. Further, in the low power state, a WTRU may not perform PLMN selection and cell selection and re-selection. Also, data transmission to and from a WTRU may not be possible when the WTRU is in the low power state. In particular, no system multicast (SM) signaling may be permitted, and the MME/SGSN may reject any SM or end system multicast (ESM) signaling requests from a WTRU (e.g., PDN connectivity/Activate packet data protocol (PDP) context requests). Further, the network and the WTRU may be required to delete any temporary mobile subscriber identity (TMSI) or packet TMSI (P-TMSI) assigned to the WTRU when the WTRU enters the low power state.

A WTRU may enter the low power state in a number of different ways. For example, a WTRU transition to the low power state may be triggered by the network during a detach procedure. For example, the transition may be triggered in a Detach Accept message for a WTRU initiated detach procedure or in a Detach Request message for a network initiated detach procedure. For another example, the transition to the low power state may be made mandatory for a set of WTRUs in a cell, and information regarding this requirement may be sent to the WTRUs either in the broadcast channel or with dedicated signaling. In this example, all WTRUS that are part of the set may enter the low power state when not attached to a wireless network. The set may include all WTRUs in the cell or a subset of all of the WTRUs in the cell. For another example, transition to the low power state may be optional for WTRUs, and a WTRU may notify the wireless network that it supports the low power state during an attach procedure. For another example, the low power state may be configured in the WTRU using Open Mobile Alliance (OMA) Device Management (DM) or Subscriber Identity Module (SIM) or Universal Subscriber Identity Module (USIM) Over-the-air programming (OTA) procedures. In this embodiment, the WTRU may always attach in the low power state unless otherwise instructed by the wireless network (e.g., when the wireless network sends a paging indication to the WTRU).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver configured to transmit idle mode discontinuous reception (DRX) parameters to a serving general packet radio service (GPRS) support node (SGSN)/mobile management entity (MME) during one of a tracking area update (TAU) and a routing area update (RAU) procedure, wherein the DRX parameters are for a DRX mode of operation that has longer DRX intervals than a regular DRX mode of operation; and
a processor configured to control the WTRU to implement the DRX mode of operation using the transmitted DRX parameters.

2. The WTRU of claim 1, wherein the WTRU is configured to communicate via machine-to-machine (M2M) type communication.

3. A method implemented in a wireless transmit/receive unit (WTRU), the method comprising:
transmitting idle mode discontinuous reception (DRX) parameters to a serving general packet radio service (GPRS) support node (SGSN)/mobile management entity (MME) during one of a tracking area update (TAU) and a routing area update (RAU) procedure, wherein the DRX parameters are for a DRX mode of operation that has longer DRX intervals than a regular DRX mode of operation; and
implementing the DRX mode of operation using the transmitted DRX parameters.

4. The method of claim 3, wherein the WTRU is configured to communicate via machine-to-machine (M2M) type communication.

5. A network node comprising:
a transceiver configured to receive idle mode discontinuous reception (DRX) parameters from a wireless transmit/receive unit (WTRU) during one of a tracking area update (TAU) and a routing area update (RAU) procedure, wherein the DRX parameters are for a DRX mode of operation that has longer DRX intervals than a regular DRX mode of operation; and
a processor configured to configure the WTRU to implement the DRX mode of operation using the received DRX parameters.

6. The network node of claim 5, wherein the network node is a serving general packet radio service (GPRS) support node (SGSN)/mobile management entity (MME).

7. The network node of claim 5, wherein the WTRU is configured to communicate via machine-to-machine (M2M) type communication.
